(19) United States
(12) Patent Application Publication
(10) Pub. No.: US 2014/0379661 A1
(43) Pub. Date: Dec. 25, 2014

(54) MULTI SOURCE UNIFIED SEARCH

(71) Applicant: Cloudfinder Sweden AB, 15 Taby (SE)

(72) Inventors: Nyman Marcus, Lund (SE); Daniel Karrholm, Lund (SE)

(73) Assignee: Cloudfinder Sweden AB, 15 Taby (SE)

(21) Appl. No.: 14/088,023

(22) Filed: Nov. 22, 2013

Related U.S. Application Data
(60) Provisional application No. 61/837,343, filed on Jun. 20, 2013.

(51) Int. Cl. G06F 17/30

(52) U.S. Cl. CPC G06F 17/30289
USPC 707/673

(57) ABSTRACT

The disclosure relates to searching data in multiple separate databases, such as searching data spread over the internet in different cloud based services. In one aspect, a method of performing a search action on data that is distributed in multiple data storages, includes collecting copies of standard objects associated with the entity from at least one of the data storages, storing the copies, reading information in the copies including information about the objects and storing the information in an index. The method may also include performing a single search action in the archive comprising the copies using the index. Because the archive comprises copies of the data, performing a search action in the archive corresponds to performing the search action in the multiple data storages. Hence, a simple way of performing a unified search on distributed data is provided.

### CROSS-REFERENCE TO RELATED APPLICATION

This application claims priority under 35 U.S.C. §119 based on U.S. Provisional Patent Application No. 61/837,343, filed Jun. 20, 2013, the disclosure of which is hereby incorporated by reference herein.

### TECHNICAL FIELD

The disclosure relates to searching data in multiple separate databases, and in particular to searching data spread over e.g., the internet in different cloud based services. The disclosure further relates to methods for searching data, a computer program for performing the methods, as well as to a searching system.

### BACKGROUND

A paradigm shift is happening, wherein many companies are going from having all their data in their own data centers to having their data spread over the internet in different cloud based services. Hence, with e.g., salesforce.com and other hosted enterprise solutions the enterprise's data and other assets are being distributed all over the internet in other data centers of the application vendors. Email, documents and CRM (Customer relationship management) are examples of such services. For organizations using several cloud services, it is often time consuming to find information relating e.g., to a particular event or a particular person with a simple search, because each service stores it data in a separate cloud database. Each cloud database is typically accessed using a web interface, which requires login with username and password.

With information divided in different cloud based solutions, there is no one place to access all information associated with a user (or several users). Logging in into several web interfaces is time consuming.

There are prior art solutions, aiming at aggregating content from distributed sources. U.S. Pat. No. 7,908,647 discloses a master server system for aggregating content from several online services, such as different e-mail providers and different social networking services, into the master server. From there, all the aggregated content could be searched using a single search interface.

Another example is US patent application U.S.2011047480, which discloses a method for searching through a user's all different cloud services seamlessly. All user data from the cloud services could also be backed up to a single location, either locally or to another cloud.

However, these solutions are rather complex and the aggregation tool needs to continuously communicate with the distributed servers in order to collect information. Such a solution takes processing power and loads the network.

### SUMMARY OF THE INVENTION

This disclosure provides a method of performing a search action on data associated with an entity, wherein the data is distributed in multiple separate data storages. The method comprises collecting copies of standard objects associated with the entity from at least one of the separate data storages, storing the copies in an archive, reading information in the copies including information about the objects and storing the information in an index and performing a single search action in the archive comprising the copies using the index. Because the archive comprises copies of the data in the data storages the step of performing a search action in the archive corresponds to performing the search action in the multiple separate data storages. Hence, a simple way of performing a unified search on distributed data is provided.

According to one aspect, the method further comprises retrieving the objects revealed in the search, from the archive. According to one aspect, the method further comprises presenting the retrieved objects. According to one aspect, the method further comprises presenting at least one link to the retrieved objects.

According to one aspect, the archive is cloud based. According to one aspect, the data storages are cloud based.

According to one aspect, the index comprises a link to the copies stored together with the information about the objects. According to one aspect, a link to the original data in respective database is also provided.

The method according to any of the preceding claims, where according to one aspect, in the search action also includes erased or deleted information.

According to one aspect, the method further comprises identifying user collaborations and communications using the retrieved objects and storing information regarding user collaborations and communications in an event index. According to one aspect, user collaborations are identified by identifying objects being accessed by several users.

According to one aspect, the single search action comprises searching for user collaborations.

According to one aspect, the invention relates to a computer program, comprising computer readable code which, when run on a controller in, causes the controller to perform the method as described above.

According to one aspect, the invention relates to a searching system for performing a search action on data associated with an entity, wherein the data is distributed in multiple separate data storages.

The method comprises an archive configured to store standard objects, an index configured to include information about the objects in the archive and a controller. The controller is configured to collect copies of standard objects associated with an entity from at least one of the separate data storages, store the collected copies in the archive, read information in the copies including information about the objects and store the information in the index and perform a single search action in the archive comprising the copies using the index, wherein performing a search action in the archive corresponds to performing the search action in the multiple separate data storages.

According to one aspect, the searching system further comprises a web interface for accessing the controller.

With the above description in mind, the object of the present disclosure is to overcome at least some of the disadvantages of known technology as previously described.

### BRIEF DESCRIPTION OF THE DRAWINGS

The present technique will be more readily understood through the study of the following detailed description of the embodiments/aspects together with the accompanying drawings, of which:

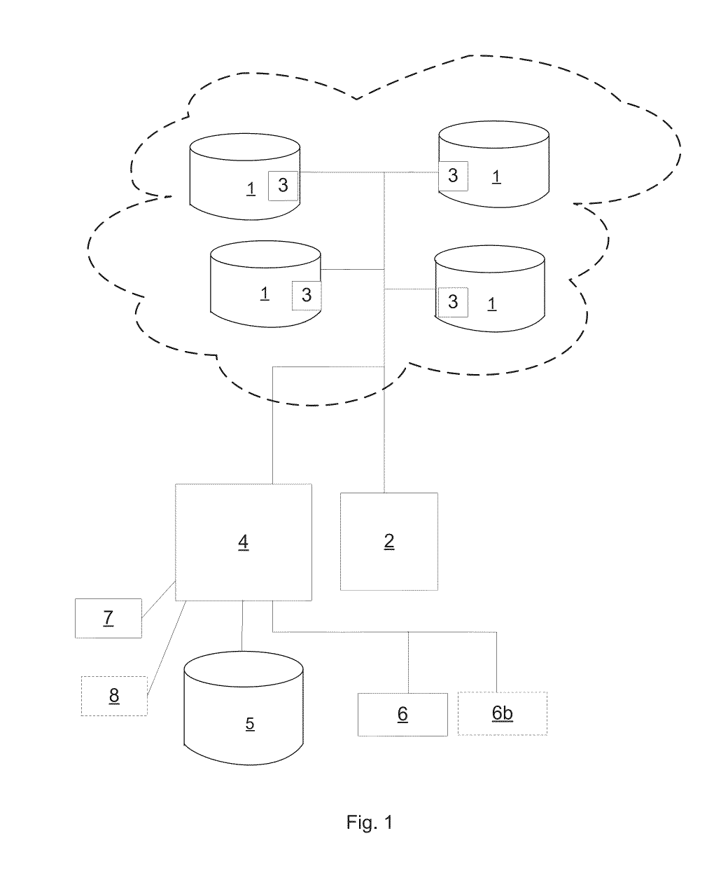

1. FIG. 1 illustrates an environment where the invention is typically implemented.

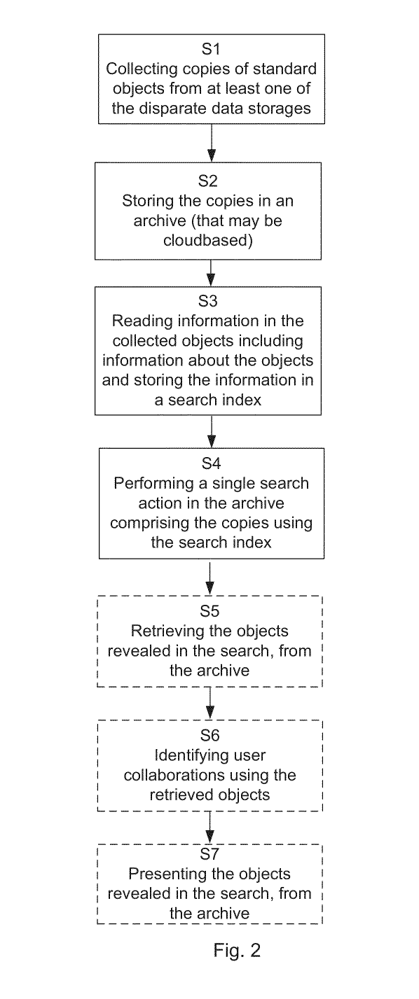

2. FIG. 2 is a flow chart illustrating the method of performing a search action according to an exemplary embodiment of the present disclosure.

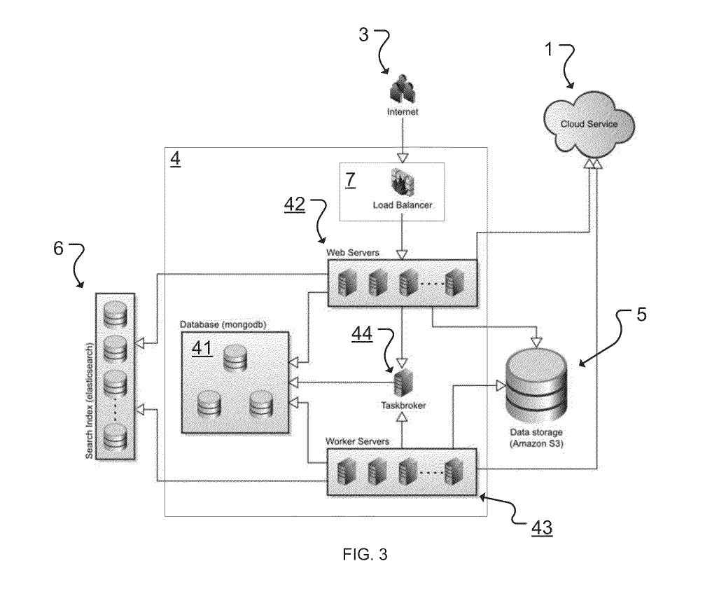

3. FIG. 3 discloses an example of a system architecture of the unified search system.

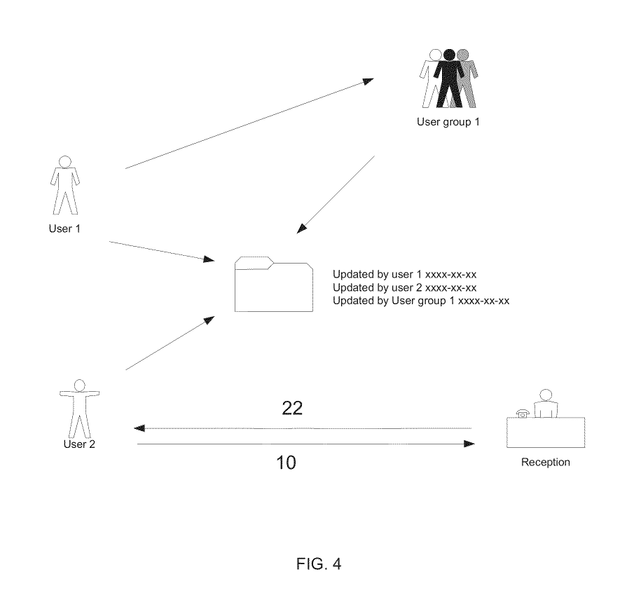

4. FIG. 4 shows an example of a presentation of a business collaborations search.

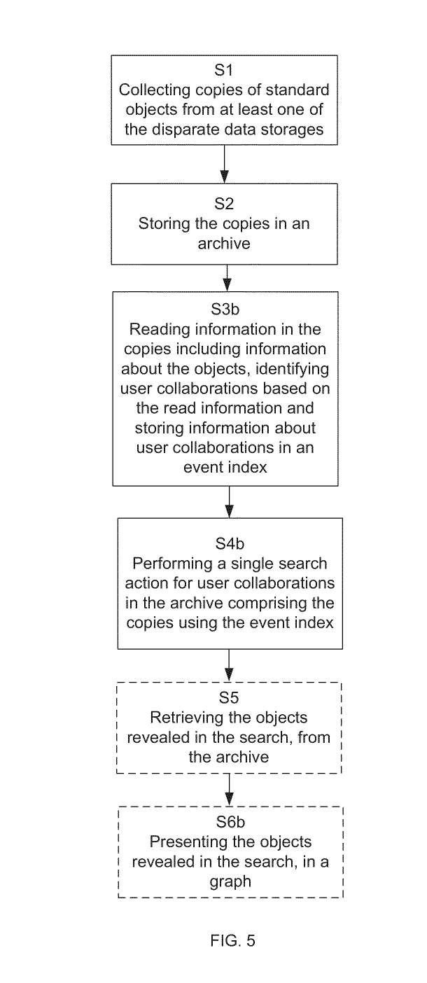

5. FIG. 5 is a flow chart illustrating a method of performing a business collaborations search according to one embodiment of the present disclosure.

It should be added that the following description of the embodiments is for illustration purposes only and should not be interpreted as limiting the disclosure exclusively to these embodiments/aspects.

### DETAILED DESCRIPTION

The general object or idea of embodiments of the present disclosure is to address at least one or some of the disadvantages with the prior art solutions described above as well as below. The various steps described below in connection with the figures should be primarily understood in a logical sense, while each step may involve the communication of one or more specific messages depending on the implementation and protocols used.

The invention is based on the idea to, for one or several users of one or several cloud services, create and continuously update a common back up or archive comprising data from all the cloud services associated by the user(s) and to make a corresponding search index. Through the archive a complete information overview of the data of all the cloud services of the user(s) is provided. It is then possible to search or filter data, in the archive and thereby access all the user's data (or at least a copy thereof). According to one aspect of the invention, the archive is used to investigate user collaborations in an organization. The archive and the index is then a powerful business intelligence tool.

Hence, according to one aspect of the invention, a unified search is performed in a back-up archive, wherein the backup itself comprises all information needed for doing the search. Hence, because the data in the archive is a copy of the data in the data storages, the search results may represent the results that would have been revealed by directly searching each data storage. The backup is updated at frequent intervals, but not during the search. Such a solution is more simple that the complicated aggregators in the retrieved documents. Through the archive search historical information may be revealed in addition to the present data. This implies that the archive search may provide further information regarding history and different versions. Furthermore, it provides for possibility to combine a back-up archive and a search tool.

FIG. 1 discloses a system for performing a search action on data associated with an entity 2, wherein the data is distributed in multiple separate data storages 1. In this application a data storage is a media for electronically storing data. The data storage typically stores a relational database.

In this example one entity 2, e.g., an enterprise, utilises several cloud services 1. Note that the entity 2 may correspond to one or several users or user accounts. In normal operation the cloud services 1 and the corresponding data may be accessed by a user 2, using e.g., a web interface 3. However, as mentioned before, this interface is not suitable for searching several data storages simultaneously.

The search system disclosed in FIG. 1 comprises a controller 4, an archive 5, an index 6 and a web interface 7.

The archive 5 is a data storage configured to store standard objects. According to one aspect, the archive 5 is a back-up. Standard objects are e.g.: Email, Document, Calendar Event, Contact, Web page, Database Record etc. As an example for salesforce Standard Salesforce objects are Accounts, Contacts, Leads, Opportunities, etc.

The index 6 is a standard search index of the archive 5. The index 6 is configured to include information about the objects in the archive for search engine indexing. Search engine indexing collects, parses, and stores data to facilitate fast and accurate information retrieval. Popular engines focus on the full-text indexing of online, natural language documents. The index is updated every time the archive is updated. According to one aspect, the index comprises a link to the copies stored together with the information about the objects.

The controller controls the method of collecting, indexing and searching data, which is further described in relation to FIG. 2. The controller 4 may also be a cloud service i.e., cloud implemented. An administrator user account with privileges to all objects and files of all the services 1 authorizes the cloud controller 4 to access all the data of all databases 1. The authorization may be done using the OAuth protocol, which allows the controller 4 to access e.g., Salesforce content all the while maintaining privacy (the Salesforce login credentials are never received or stored by cloud controller).

The controller 4 is configured to:

1. collect copies of standard objects associated with an entity from at least one of the separate data storages 1;

2. store the collected copies in the archive 5;

3. read information in the copies including information about the objects and store the information in the index 6; and

4. Perform a single search action in the archive comprising the copies using the index, wherein performing a search action in the archive corresponds to performing the search action in the multiple separate data storages.

With a regular interval, e.g., every 24 hours, the cloud controller 4 scans and backs up or copied from the databases 1 and stored in a back-up archive 5. The archive 5 is typically also cloud implemented. Then the archive 5 has unlimited storage. The data in the data may be encrypted with Server Side Encryption (SSE) using one of the strongest block ciphers available, 256-bit Advanced Encryption Standard (AES-256). Each account is assigned a unique key which is used to encrypt all your data, thus ensuring that no one can gain access to your information.

According to one aspect of the invention, the cloud controller uses Amazon S3 as default storage. (See http://aws.amazon.com/s3/ for more information about S3). Such a solution provides a highly durable storage infrastructure designed for mission-critical and primary data storage. Objects are then redundantly stored on multiple devices across multiple facilities. Such a solution gives high durability and availability of objects over a given year.

The first time the cloud controller creates a back-up it may take a relatively longer time, typically 48-72 hours, to complete the initial scan and backup of the data. The first scan typically comprises logging in to each server, reading and copying all objects in each server and storing the copies in the archive. The next time the scan is performed, only new or amended data/documents needs to be copied. As an alternative, all documents may be copied each time the services are scanned. The cloud controller updates the index every time the services are scanned.

According to one aspect of the invention, once your data is in the archive, it is never deleted. According to one aspect, deletion isn't even possible through the web interface, which means your backup data is always protected against user errors and attacks.

The cloud controller 4 has a web interface 7, through which a user can e.g., search features to retrieve a document, search through objects or find content. Through the web interface a user may download or restore previous versions or retrieved documents of the content within a few seconds.

The invention is based on the idea that the archive (or backup) itself comprises all information needed for doing a search in all the backed-up databases. In principle the archive is a mirror of all a user's data, which is updated at frequent intervals, but not during the search. Hence, by adding an index to the archive a unified simple search is provided. Even if cloud services have user-friendly user interfaces and API's, it's time-consuming to log in to several services and use search functionality that differs between services. Unified search offers a simple, standardized method to search and filter information. Furthermore, it is not necessary to log in into each database.

The proposed technique is more simple that the complicated aggregators of prior art, because the search is performed in one single index. Furthermore, if information from cloud services is continuously backed up, historical searches and version analysis are possible. The backup may also be used as a traditional backup solution. Hence, no further back-up is required.

The method of performing a search action on data associated with an entity, wherein the data is distributed in multiple separate data storages, will now be disclosed in relation to FIG. 2. An entity here refers to a unit having a defined amount of data within the data storages. An entity is e.g., an enterprise or one or several user accounts.

The method comprises collecting S1 copies of standard objects associated with the entity from at least one of the separate data storages. Hence, the cloud controller 4 securely connects to each cloud database and collects or copies S1 standard objects associated with an entity e.g., an enterprise or a user, in at least one cloud database. The original version is not affected by the copying. Typically all objects of the entity's account or accounts are collected or copied. This may be done using the APIs provided by the respective cloud service, e.g., SOAP or REST. The access to the API typically involves authorisation. This may e.g., be done every 24 hours.

The retrieved objects are then copied S2 or backed up in an archive. The archive is typically another cloud database having no maximum storage limit Thus, the archive comprises a back-up of all the files belonging to a user.

In the next step, the cloud controller reads S3 information in the copies including information about the objects and stores the information in an index. This may be done before, after or in parallel with the copying S1 and storing S2. The information is typically stored in the index together with a link to the respective file. According to one aspect of the invention, the cloud controller can read information in all common file formats and will by this step make all content searchable in the index.

In the next step, a single search action is performed S4 in the archive comprising the copies using the index. Performing a search action implies requesting objects from the data storage that fulfils certain criteria. A search action is e.g., a key word search. The search action may also be a filter e.g., all files changed during a certain time or all spreadsheet created last year. According to the invention performing a search action in the archive corresponds to performing the search action in the multiple separate data storages. Hence, by performing a single search action in the index, whereby a search of the entity's information from multiple cloud databases is performed. This is typically done by accessing the cloud controller via e.g., a web interface 7, where a search string is inputted. Hence, the user may log in to another interface and there search data of several cloud based services.

Thereby, searching for information from all sources, including deleted information and previous versions of data, is possible with a single search action in the index. One advantage of this aspect of the invention is that not only the present information is included in the search, but also historical information. For example, if a person has left the company, it is possible to search that person's data. The search may according to one aspect of the invention also include erased or deleted information.

Filters can be applied and used for data from all sources. For example it may be possible to only search for emails, text documents or presentations. It may be possible to add filters for dates etc. in one source.

According to one aspect, the method further comprises retrieving S5 the objects revealed in the search, from the archive. The object may e.g. be fetched and sent to the user performing the search action.

According to one aspect, the method further comprises presenting S6 the retrieved objects to the user performing the search action. The objects may be presented in several ways. One example is a list of objects. According to one aspect, the method further comprises presenting S6a at least one link to the retrieved objects.

The archive and the index may also be cloud based. According to one aspect the cloud controller is a cloud based service. According to one aspect, the archive is cloud based. According to one aspect, the data storages are cloud based.

According to one aspect, a link to the original data in respective database is also provided.

The invention also relates to a computer program, comprising computer readable code which, when run on a controller in, causes the controller to perform the method as described above.

An example of system architecture of the unified search system like the one in FIG. 1 is disclosed in FIG. 3. The system is adapted to back up user data for several users using multiple distributed services. The system is further adapted to provide a search interface to search the data of the distributed services. The searching system comprises a cloud controller 4, an archive 5 and an index 6.

The cloud controller 4 is controlling the search. In this embodiment the cloud controller 4 comprises a web interface 7, a taskbroker 44 and a number of servers 42, 43 for executing the search methods described above. In this example there is one set of worker servers 43 and one set of web servers 42. The cloud controller also comprises an internal database 41.

The web servers 42 handle incoming HTTP requests to the application website and the API. It is critical for users to be able to navigate and search their backup. Asynchronous tasks are handed over to the taskbroker 44 for delivery to other parts of the system.

The taskbroker 44 tracks asynchronous message delivery to the worker processes of the worker servers 43. It receives messages from both web servers 42 and worker servers 43 and delivers them one by one to whichever process asks for the next task. Apache ActiveMQ may be used for storage of the message queues.

The worker servers 43 run several processes to retrieve tasks from the taskbroker 44. Each process runs a task until it is completed or the process gets interrupted because of an error. The completion status is reported back to Taskbroker 44. Errors from external systems are solved by retrying using exponential back-off, before it is raised as an issue.

The worker servers 43 are e.g., configured to execute the following asynchronous task types:

1. Scan task; This task backs up changed data, stores it safely, and indexes it.

2. Restore task; This task retrieves selected data and uploads it to a target destination.

3. Export task; This task retrieves selected data and prepares it in a downloadable format.

4. Mail task; This task handles sending messages to external recipients (e.g. organization admins).

The index 6 is a fully scalable search index, based on e.g., Lucene. According to one aspect, each organization has a separate index 6. Indexed data is stored by the worker servers 43 and are used in the web servers 42 to search.

The Database 41, is used to store account information, settings, statuses, and state information needed during performed tasks. In this example, the database is a document-based database, as opposed to relational models. The web servers 42 use the database to store selected settings and to show information (e.g., status of previous scans).

The taskbroker 44 uses the database to update statuses of currently running tasks and parent tasks. The worker servers 43 use the database to read settings and to store information needed during processing of certain tasks.

### Storage & Encryption

Once downloaded, the copied or collected data is stored in AWS S3 storage, which can only be accessed by the application itself. Stored items are only directly accessed by the application behind the firewall. The data is encrypted with Server Side Encryption (SSE) using one of the strongest block ciphers available, 256-bit Advanced Encryption Standard (AES-256).

The archive is e.g., a storage with SFTP or Linux compatible file systems. Customer accounts receive unique AES 256-bit encryption keys, used to encrypt all data prior to storage. Account and key information is encrypted and not available outside the application.

### Security

According to one aspect, the search system is designed thoroughly with security in mind, which means that the data is encrypted in both transit and storage. All transfers made from and to cloud services are done over SSL encrypted connections, using HTTPS by standalone processes running behind a firewall.

Once downloaded, the data is stored in encrypted in Standard (AWS S3) or Custom storage, which can only be accessed by the application itself. Stored items are only directly accessed by the application behind the firewall, and all control of the application by the administrator user is done through a login-restricted web interface over HTTPS.

### Business Intelligence (BI) Search

According to a particular aspect of the invention, the disclosure relates to a method of finding business collaborations in the archive.

Today many companies often have an organization with predefined communication interfaces between different departments. In badly working organizations, one problem may be that informal ways are used instead of the predefined communication ways, leading to inefficient procedures.

Therefore, analysis of communication patterns is a very efficient tool in organization and business improvements. However, the task of finding informal communication ways is not always easy.

One proposed solution is the use of email for analysis of communication patterns in collaborative innovation networks. However, such a solution gives a rather limited picture of the information flow.

Today's solutions of finding communication patterns are generally at least partly manual.

This aspect of the invention gains business insights and discover communication patterns through an automated process of storing, grouping and making available statistics regarding different kinds of digital communication and sharing of information between defined (existing or dynamically defined in real-time) user groups, departments and external users.

This aspect of the invention builds on the realization that the archive 5 typically comprises information regarding, who has emailed whom and when. How information is shared and who have accessed the same document.

The method is typically executed in the environment disclosed in FIG. 1. According to one aspect the Business Intelligence or user collaboration search is implemented using a BI interface 8 and an event index 6b. However, the functions implemented in these blocks may as well be implemented in the other modules.

According to this particular aspect the invention relates to a method, of searching user collaborations which is used for illustrating business associations, illustrated in FIGS. 4 and 5.

According to this particular aspect the step of reading S3 information in the copies further comprises identifying S3b user collaborations and communications using the retrieved objects and storing information regarding user collaborations and communications in an event index. This aspect of the disclosure comprises storing S3b the user collaborations as event objects in suitable format. Examples of event objects are chat, email and document sharing. The stored events or event objects typically comprise information about what happened and when, and who were involved. The event index may be integrated with the index. Because the archive comprises historical information, it is a valuable source in analyzing historical document access or versions.

According to one aspect, user collaborations are identified by identifying objects having been accessed by several users.

Then, the single search action comprises searching S4b for user collaborations. The search may e.g., be searching for all events associated with user A or B. Hence, in the method of investigating communication patterns the step of performing a single search S4 comprises searching standard communication event objects associated with a search request originating from multiple databases comprising different types of data. Standard communication events is e.g., chat, email, SMS but also document sharing. One of the interesting aspects is that sharing of data is considered a communication event. The search request could be a search for a keyword, user, document, time or other object, customer.

According to one aspect, collaborations are identified by identifying objects being accessed by several entities. In such analysis document history and access history are properties of the event that may be taken into account.

Hence, through the BI search, documents being communication events and matching the search string are retrieved. Then the collaborations between and actions related to the event objects are presented to the user. User collaborations are typically presented in a graph, like the one in FIG. 4. FIG. 4 discloses the number of communications e.g. emails exchanged between different users. FIG. 4 also illustrates that one folder has been accessed and updated by several users.

The graph in FIG. 4 illustrates messages exchanged between users and user groups. It also illustrates users or user groups that have accessed a document folder.

Example: It will be possible to create an aggregate statistics regarding communication between Sales and R&D by identifying emails, documents etc. associated with both business groups. Then, unwanted communication channels may be identified.

Through this aspect of the invention one can avoid collecting different types of information from several sources and instead in a very easy way present collaboration patterns in an organization. The solution is suitable for companies using a cloud based services.

With access to an organization's entire email archives, documents and CRM data, the archive database can provide Management, HR, Legal, IT and other end users with answers to these types of questions:

Is communication between departments efficient? Is the mood or sentiment of the workforce changing? Are we interacting with key clients or prospective customers according to our standards? Are we responsive to our key stakeholders?

1. A method of performing a search action on data associated with an entity, wherein the data is distributed in multiple separate data storages, comprising:
collecting copies of standard objects associated with the entity from at least one of the separate data storages;
storing the copies in an archive;
reading information in the copies including information about the objects and storing the information in an index; and
performing a single search action in the archive comprising the copies using the index, wherein performing a search action in the archive corresponds to performing the search action in the multiple separate data storages.

2. The method according to claim 1, further comprising:
retrieving the objects revealed in the search, from the archive.

3. The method according to claim 1, further comprising:
presenting the retrieved objects.

4. The method according to claims 3, further comprising:
presenting at least one link to the retrieved objects.

5. The method according to claim 1, wherein the archive is cloud based.

6. The method according to claim 1, wherein the data storages are cloud based.

7. The method according to claim 1, wherein the index comprises a link to the copies stored together with the information about the objects.

8. The method according to claim 1, wherein a link to the original data in respective database is also provided.

9. The method according to claim 1, wherein the search action also includes erased or deleted information.

10. The method according to claim 9, further comprising,
identifying user collaborations and communications using the retrieved objects and storing information regarding user collaborations and communications in an event index.

11. The method according to claim 9, wherein user collaborations are identified by identifying objects being accessed by several users.

12. The method according to claim 1, wherein the single search action comprises searching for user collaborations.

13. A computer program, comprising computer readable code which, when run on a controller in, causes the controller to perform the method of claim 1.

14. A searching system for performing a search action on data associated with an entity, wherein the data is distributed in multiple separate data storages, comprising:
an archive configured to store standard objects;
an index configured to include information about the objects in the archive; and
a controller configured to:
collect copies of standard objects associated with an entity from at least one of the separate data storages;
store the collected copies in the archive;
read information in the copies including information about the objects and store the information in the index; and
perform a single search action in the archive comprising the copies using the index, wherein performing a search action in the archive corresponds to performing the search action in the multiple separate data storages.

15. The searching system according to claim 14, wherein the searching system further comprises a web interface for accessing the controller.
